(19) United States
(12) Patent Application Publication
(10) Pub. No.: US 2024/0279109 A1
(43) Pub. Date: Aug. 22, 2024

(54) RARE EARTH DOPED GLASSES AND THEIR APPLICATION

(71) Applicant: UNM RAINFOREST INNOVATIONS, Albuquerque, NM (US)

(72) Inventors: Brian TOPPER, Albuquerque, NM (US); Arash MAFI, Albuquerque, NM (US); Johann Richard WEBER, Arlington Heights, IL (US); Stephen Kenneth WILKE, Evanston, IL (US)

(73) Assignee: UNM RAINFOREST INNOVATIONS, Albuquerque, NM (US)

(21) Appl. No.: 18/443,686

(22) Filed: Feb. 16, 2024

Related U.S. Application Data
(60) Provisional application No. 63/485,680, filed on Feb. 17, 2023.
(60) Provisional application No. 63/508,256, filed on Jun. 14, 2023.

(51) Int. Cl. C03C 3/12; C03C 4/10

(52) U.S. Cl. CPC C03C 3/127; C03C 4/10

(57) ABSTRACT

According to examples of the present disclosure, a glass product is disclosed that includes a composition of which comprises at least 50 molar percent titanium dioxide and at least 0.1 molar percent rare earth metal oxide wherein the rare earth is at least one of the following elements: scandium, yttrium, lanthanum, cerium, praseodymium, neodymium, promethium, samarium, europium, gadolinium, terbium, dysprosium, holmium, erbium, thulium, ytterbium, lutetium.

### CROSS REFERENCE TO RELATED APPLICATION

This application claims priority to U.S. Provisional Patent Application Ser. No. 63/485,680 filed on Feb. 17, 2023 and U.S. Provisional Patent Application Ser. No. 63/508,256 filed on Jun. 14, 2023, the contents of both are hereby incorporated by reference in their entirety.

### GOVERNMENT SUPPORT

This invention was made with government support under Grant No. DE-SC0018601 awarded by the Department of Energy (DOE), Grant No. FA9451-22-2-0016 awarded by the Air Force Research Laboratory, and Grant No. 80NSSC19K1288 awarded by NASA. The government has certain rights in the invention.

### FIELD OF THE DISCLOSURE

The present disclosure relates to rare earth doped glasses, and in particular to mid-infrared luminescence properties of erbium and dysprosium doped lanthanum titanate glasses and other properties of other rare earth doped glasses. The present disclosure likewise relates to transition metal oxide glasses, and in particular to rare-earth titanate glasses that may or may not have optically active ions incorporated within them but nonetheless possess desirable optical properties, such as broadband transmission or the behavior of the optical susceptibility.

### BACKGROUND

High-power and compact mid-infrared (MIR) sources and detectors are currently in demand for industrial, directed energy, remote sensing, spectroscopic and biomedical applications. Silica fiber lasers offer a choice solution for sources up to 2 μm, though they are generally impractical for wavelengths beyond 2.5 μm. Current compact mid-infrared sources that are commercially available employ fluoride fiber lasers, in which significant progress has been made in recent years. However, fluoride glasses have a low glass transition temperature (T_{g}), roughly between 520-570 K, making them prone to damage at high pump powers. Aside from low thermal stability, fluoride-based glasses display comparatively poor chemical and mechanical properties relative to oxide glasses.

Efforts to provide alternatives to fluoride glasses for MIR applications that have better physical properties focus usually on oxide glass systems, with tellurites receiving the most attention. Other studied hosts include germanates, gallates, and ‘heavy metal oxide’ glasses. By far, the MIR transition most investigated in oxide materials is erbium's ⁴I_{11/12}→⁴I_{13/2} transition at circa 2700 nm (see FIG. 1A, FIG. 1B, FIG. 1C), which has only recently been made to lase in a tellurite glass fiber for the first time. On the other hand, Dy³⁺ is scarcely studied in oxide hosts, although Gomes et al. have indicated there is potential for Dy³⁺ doped TeO₂ glasses to achieve population inversion beyond 3 μm at the Dy³⁺:⁶H_{13/2}→⁶H_{15/2} transition (see FIG. 1A, FIG. 1B, FIG. 1C). This transition belonging to Dy³⁺ has received a great deal of attention in fluoride hosts recently due, in part, to the large tuning bandwidth and in-band pumping potential. Despite continuing progress in fluoride glasses, the enhanced durability enabled by oxygen cross-linked network formers remains of interest. In addition to active optical elements and gain media, a diverse portfolio of robust materials with differing properties is desirable for the design of lens arrays, beam delivery, frequency conversion, and other optical functions.

### SUMMARY

According to examples of the present disclosure, binary or mixed rare-earth titanates for mid-infrared photonics comprising glasses having a high glass transition temperature, exhibiting low OH ion concentrations and associated absorption bands, transparency from the UV out to 6 microns, and a large Raman gain bandwidth are disclosed. In another example, the present disclosure provides for undoped or doped lanthanum titanate glasses that offer the thermal stability of a hard glass (i.e., relatively mechanically, thermally and chemically stable) with the host properties typically associated with soft (i.e., relatively mechanically weak, thermally and chemically unstable) glasses for application in visible, near-infrared, and mid-infrared photonic applications.

A system, device and method comprising mid-infrared photonics with glasses having a high transition temperature, exhibiting low OH, and 1 mm thick discs are transparent out to 6 μm. A system, device and method comprising doped lanthanum titanate glasses that offer the thermal stability of a hard glass with the host properties typically associated with soft glasses while allowing high quantities of active rare-earth elements to be dissolved. A system, device and method comprising undoped or doped lanthanum titanate glasses having large Raman gain bandwidth. A system, device and method comprising doped lanthanum titanate glasses where the inhomogeneously broadened lineshape of the dopant ion is exploited for conventional and unconventional wavelength operation and/or tunability. A system, device and method comprising undoped or doped lanthanum titanate glasses for any of the above seen or unforeseen applications where the undoped or doped lanthanum titanate glass is used in the form of a sphere, a disc, or a clad or unclad fiber or waveguide.

Glasses of composition xRE₂O₃-(17-x) La₂O₃-83 TiO₂ were prepared by levitation melting from x=0.1 to 9 for RE=Er and at x=0.1 and 1 for RE=Dy. The glasses have high transition temperature, exhibit low OH, and 1 mm thick discs are transparent out to 6 μm. Mid-infrared emission lineshapes and lifetimes are comparable to what is seen in tellurite glasses containing Er³⁺ and Dy³⁺. For x fixed at 1, the Er³⁺:⁴I_{11/12}→I_{13/2} transition at 2716 nm has a fluorescence lifetime of 254 μs and the Dy³⁺:⁶H_{13/2}→⁶H_{15/2} transition at 2957 nm has a fluorescence lifetime of 9.09 μs. The results indicate that doped lanthanum titanate glasses offer the thermal stability of a ‘hard’ glass with the host properties typically associated with ‘soft’ glasses.

According to examples of the present disclosure, optically active glasses that contain a rare earth metal oxide component are disclosed. By tailoring the composition and processing of the glasses, useful and novel optical behavior is achieved. The interaction between optically active components and the host is controlled via composition and processing to control optical properties and fluorescence behavior. Fluorescence behavior is further controlled via wavelength of incident light source(s) and the intensity of the light source in the glass.

### BRIEF DESCRIPTION OF THE FIGURES

The accompanying drawings, which are incorporated in and constitute a part of this specification, illustrate embodiments of the present teachings and, together with the description, serve to explain the principles of the present teachings. In the figures:

FIG. 1A shows a plot of infrared transmission of 4 Er₂O₃-13 La₂O₃-83 TiO₂ glass. Not corrected for Fresnel losses. FIG. 1B shows a plot of measured UV-VIS absorbance and FIG. 1C Normalized Raman gain spectrum of 17 La₂O₃-83 TiO₂ glass.

FIG. 2 shows a plot of baseline corrected absorbance spectra of 1RE₂O₃-16La₂O₃-83TiO₂ with RE=Dy in darker dashed line and RE=Er in lighter dotted line.

FIG. 3A shows a plot of static NIR fluorescence of Er-doped lanthanum titanate (ErLT) compared to silicate and fluoride phosphate hosts (offset for clarity). FIG. 3B shows a plot of time-domain fluorescence of 1.5 μm NIR emission in ErLT. FIG. 3C shows a plot of mean lifetime values for Er^{3+ 4}I_{13/2}→⁴I_{15/2} versus erbium concentration, x. Dotted line is intended to guide the eye.

FIG. 4A shows a plot of normalized intensity versus time for Er³⁺⁴I_{11/12}→⁴I_{13/2} fluorescence decays of select ErLT glasses and FIG. 4B shows a plot of mean lifetime values as a function of erbium content, with linear fit to guide the eye. Measurements were made with a HgCdTe photodetector and a 2700 nm bandpass filter.

FIG. 5 shows a plot of area normalized mid-infrared fluorescence of 1RE₂O₃-16La₂O₃-83TiO₂ with RE=Dy in lighter dashed line and RE=Er in dark solid line.

FIG. 6 shows a plot of normalized intensity versus time for Dy³⁺ ⁶H_{13/2→}⁶H_{15/2} fluorescence decays following 1064 nm pumping recorded with HgCdTe photodetector and 2950 nm bandpass filter. Discrete data points are experimentally measured and solid lines are bi-exponential fits.

FIG. 7A shows high energy x-ray diffraction of a typical rare earth titanate glass sample. The diffraction shows only diffuse scattering that occurs in samples without long range order—i.e. those that do not contain crystals.

FIG. 7B shows a plot of intensity versus 2theta for the x-ray diffraction of FIG. 7A.

FIG. 8A shows a plot of examples of temperature-time data for processing samples in a non-contact levitation instrument.

FIG. 8B shows a diagram of glass with various compositions prepared by melting crystalline materials and cooling them to avoid formation of crystals. From L. Gomes, J. Lousteau, D. Milanese, E. Mura, and S. D. Jackson, “Spectroscopy of mid-infrared (2.9 μm) fluorescence and energy transfer in Dy³⁺-doped tellurite glasses,” J. Opt. Soc. Am. B 31(3), 429-435 (2014).

FIG. 9A and FIG. 9B show visualization of the atomic network structure in a rare earth titanate composition glass: (FIG. 9A) Network structure, illustrating Ti—O₅ and Ti—O₆ polyhedra and rare earth atoms. (FIG. 9B) Ti—Ox polyhedra are connected via bridging oxygen (O—Ti₂) and triplets (O—Ti₃), predominantly through corner- and edge-sharing. For clarity, nonbridging O (O—Ti1) are not shown.

FIG. 10 shows an example of disc fabricated from a prepared sphere similar to those presented in FIG. 8B.

FIG. 11 shows the near and mid-infrared fluorescence spectra of 5Er₂O₃-12La₂O₃-83TiO₂ (bottom line), 0.05Nd₂O₃-5Er₂O₃-11.95La₂O₃-83TiO₂ (middle line), and 0.05Pr₂O₃-5Er₂O₃-11.95La₂O₃-83TiO₂ (top line) measured under 976 nm excitation.

FIG. 12A, FIG. 12B, FIG. 12C, and FIG. 12D show in (FIG. 12A, FIG. 12B) the fluorescence decay curves at 77 K (top line) and 300 K (bottom line) for ⁴I_{11/12} (FIG. 12A) and ⁴I_{13/2} (FIG. 12B) and in (FIG. 12C, FIG. 12D) the lifetime versus temperature for ⁴I_{11/2} (FIG. 12C) and ⁴I_{13/2} n (FIG. 12D). The broken lines are drawn to guide the eyes.

FIG. 13 shows the calculated room temperature cross-sections of Yb³⁺ in lanthanum titanate glass, where the absorption cross-section, the emission cross-section determined by McCumber theory, the emission cross-section calculated using the fluorescence spectrum acquired under 900 nm excitation at room temperature and the F'uchtbauerLadenburg equation are shown as indicated in the legend.

FIG. 14 shows site-selective fluorescence spectra of 0.1% Yb₂O₃ doped lanthanum titanate glass at 77 K. The inset highlights the zero-phonon line peak at circa 977 nm.

FIG. 15 shows the experimental setup and coordinates for performing Z scan measurements with beam profiler on glass of composition 17La₂O₃-83TiO₂ using 550 picosecond pulses of 532 nm light at 500 Hz repetition rate.

FIG. 16 shows the change in transmittance through z for several incident intensity levels for a glass of composition 17La₂O₃-83TiO₂. Open symbols represent experimental data points with solid lines given by theoretical fits to the data.

FIG. 17 shows the two-photon absorption coefficient β measured for different peak intensities inside the sample. The dashed line is the mean value of all measurements. Error bars represent two standard deviations of the measured values.

FIG. 18A and FIG. 18B show the experimental change in beam radius with z for trial with I₀=2 GW/cm² in FIG. 18A and the peak-valley distances of radius measurements for different intensities (symbols) plotted with linear fit intercepting 0 (dashed line) in FIG. 18B.

FIG. 19 shows the Raman gain coefficient spectra of 17La₂O₃-83TiO₂ glass (solid line) and SiO₂ (dotted line). Normalization was done by setting the Raman gain coefficient at 440 cm⁻¹ in silica to 1.86×10⁻¹¹ cm/W. For visual aide, the spectrum of SiO₂ has been multiplied by 50 (dotted dashed line).

FIG. 20 shows a schematic diagram of the processing setup used to draw test fibers from levitated molten samples.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

Rare-earth titanates prepared by containerless melting techniques are promising materials for optical and photonic applications. Rare-earth titanates have glass transition temperatures near 1070 K, which gives them excellent thermal stability compared to fluorides and the vast majority of soft glasses. For example, tellurites typically have glass transition temperatures between 575-700 K. The uniquely high average coordination number of the network forming titanate polyhedra produces a phonon energy comparable to that of soft oxide glasses typically employed for photonic applications. Glass formation in rare-earth titanates is restricted to the larger rare-earth elements, but partial substitution of several smaller elements for La has been shown. Up-conversion luminescence has been demonstrated but near- and mid-infrared luminescence have not been investigated. It is also notable that the refractive index and dispersion are both high, with n_{d}≈2.3 and ν_{d}≈20.

A levitation melting technique is used to prepare glasses of nominal composition xRE₂O₃-(17-x) La₂O₃-83 TiO₂ with x=0 to 9 for RE=Er (xErLT) and at x=0.1 and 1 for RE=Dy (xDyLT). Crystallization was encountered at x=11 for RE=Er, where the mean ionic radius of the lanthanide constituents reached 0.940 Å. This result is in good agreement with the lower limit of the lanthanide ionic radius for binary rare-earth titanates as discussed by O. L. G. Alderman, C. J. Benmore, A. Tamalonis, and R. Weber, “Rare-earth titanate melt structure and glass formation,” Int. J. Appl. Glas. Sci. 10(4), 463-478 (2019). The synthesized glass spheres of about 2 mm diameter were mounted in acrylic, then ground and polished on two opposite sides to form disks of about 1 mm thickness.

To confirm composition, glass discs were sputter-coated with 4 nm of Au/Pd and analyzed with scanning electron microscopy and energy dispersive spectroscopy (EDS). EDS was collected at 12 sites across each glass disc. The TiO₂ content of each specimen was within 1.0 mol % of the nominal values, and the Er₂O₃ content was generally within 0.2 mol % of the nominal values. Note that the measured variations of 0.2 mol % are likely smaller than the EDS method's precision.

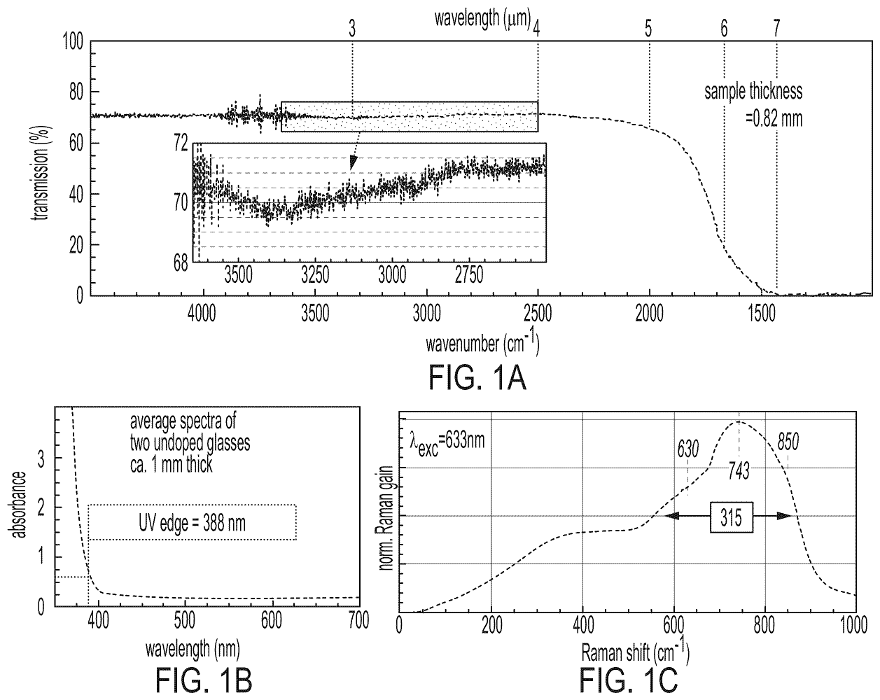

FIG. 1A shows a plot of infrared transmission of 4 Er₂O₃-13 La₂O₃-83 TiO₂ glass, not corrected for Fresnel losses. FIG. 1B shows a plot of measured UV-VIS absorbance and FIG. 1C shows the normalized Raman gain spectrum of 17 La₂O₃-83 TiO₂ glass. The infrared transmission spectrum (Shimadzu IRSpirit FTIR Spectrophotometer) is shown in FIG. 1A for a glass with 4% Er₂O₃. The glasses show good transparency throughout the whole 3-5 μm atmospheric window and reach 6 dB of the original transmission at 1655 cm⁻¹ (6 μm). The low hydroxyl species content of the glasses is evidenced by the nearly uninterrupted transmission between 3000-3500 cm⁻¹. This is highlighted with the inset of FIG. 1A, where less than 2% loss in transmission is observed in the region that OH— species in glasses have characteristic absorption bands. The UV cutoff, taken here where the absorbance per cm goes to 6, of the lanthanum titanate base glass (FIG. 1B) is at a frequency of 25751 cm⁻¹ (388 nm). This gives a 6 dB bandwidth of 24096 cm⁻¹ for glassy lanthanum titanate discs with a thickness of roughly 1 mm.

The spontaneous Raman scattering (Horiba LabRAM HR Evolution) was corrected for the Bose-Einstein thermal population factor to give the Raman gain lineshape (FIG. 1C). Stretching modes of the diverse network of titanate polyhedra give rise to a broad high frequency envelope with a maximum at 743 cm⁻¹ and a shoulder at about 850 cm⁻¹. Defined here as the 50% threshold, the nominal Raman gain bandwidth is 315 cm⁻¹, greater than silica (200 cm⁻¹) and more than twice that of tellurites (140 cm⁻¹).

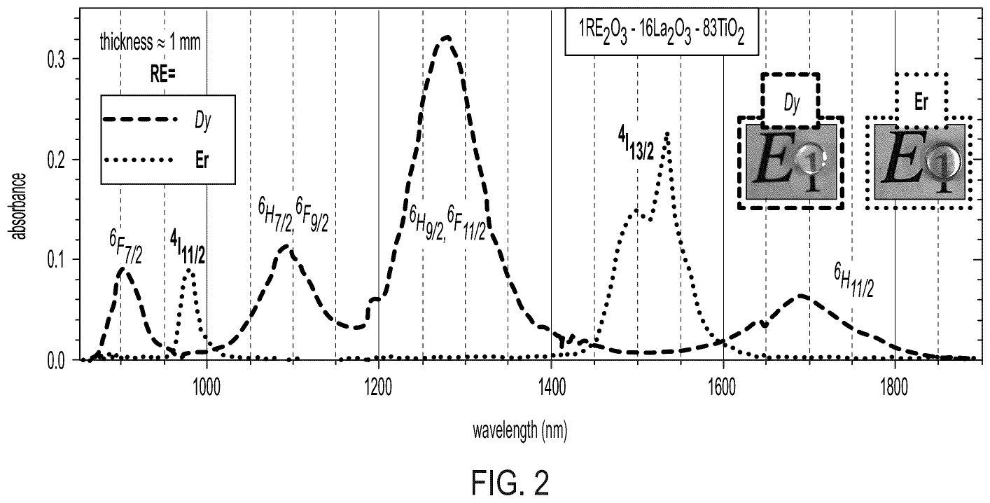

FIG. 2 shows a plot of baseline corrected absorbance spectra of 1RE₂O₃-16La₂O₃-83TiO₂ with RE-=Dy in darker dashed line and RE-=Er in lighter dotted line. Near-infrared absorption measurements (Agilent Cary 7000 UV-VIS-NIR Spectrophotometer) were made in transmission mode on glasses containing 1% active ion concentrations (see FIG. 2). For 1DyLT, band maxima are recorded at 904, 1096, 1277, and 1687 nm. For 1ErLT, band maxima are recorded at 980 and 1533 nm.

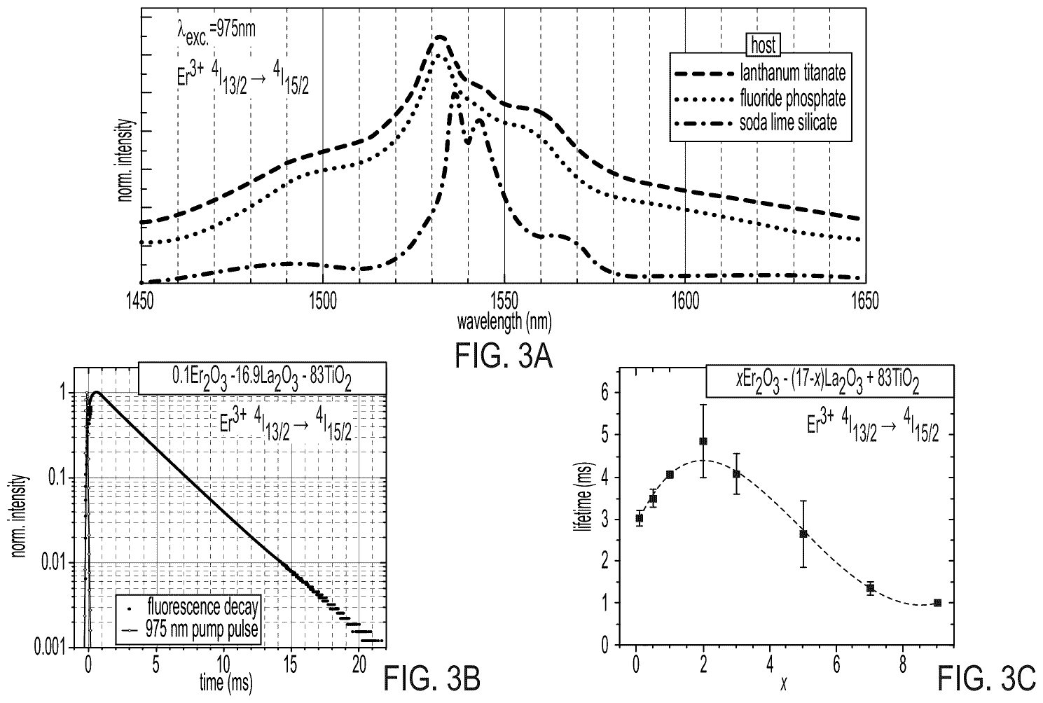

FIG. 3A shows a plot of static NIR fluorescence of Er-doped lanthanum titanate (ErLT) compared to silicate and fluoride phosphate hosts (offset for clarity). FIG. 3B shows a plot of time-domain fluorescence of 1.5 μm NIR emission in ErLT. FIG. 3C shows a plot of mean lifetime values for Er³⁺⁴I_{13/2}→⁴I_{15/2} versus erbium concentration, x. Dotted line is intended to guide the eye.

The widely used Er³⁺:⁴I_{13/2}→⁴I_{15/2} emission (measured with Yokogawa AQ6370D OSA) is shown in FIG. 3A (top line) for the glass with the lowest erbium concentration (0.1 mol %) so that reabsorption effects are negligible. The emission band, peaking at 1533 nm, is characterized by a mean wavelength of 1542 nm and an effective linewidth of 69 nm. The lanthanum titanate glass is shown alongside measurements of NIR erbium emission from a soda lime silicate glass (NCS, bottom line) and a fluoride phosphate glass (FP20, middle line). A large degree of inhomogeneous broadening in the lanthanum titanate host can be well seen by comparison of the lineshape to that of the NCS and FP20 hosts. The ErLT spectrum is much broader than the NCS host and only slightly broader than FP20. In FP20 glasses, mixed coordination environments of the RE³⁺ cation with fluorine and oxygen promote broad emission lineshapes. Large degrees of inhomogeneous broadening, such as seen here, are often suitable for broad tuning ranges.

The Lifetime of the Transition is 3.0±0.2 ms for 0.1ErLT (FIG. 3B, Determined by Using the Expectation Value Integral of Normalized Fluorescence Intensity, l(t) (r)=,

$$〈 τ 〉 = \frac{\int t I ( t ) dt}{\int I ( t ) dt} ,$$

with t=0 set at I(t)=1. This is comparable to sodium zinc lanthanum tellurite (NZLT) glasses, where intrinsic values of 3.27 ms are reported. The measured lifetimes (FIG. 3C) initially increase with increasing erbium concentration due to reabsorption effects, then fall due to quenching.

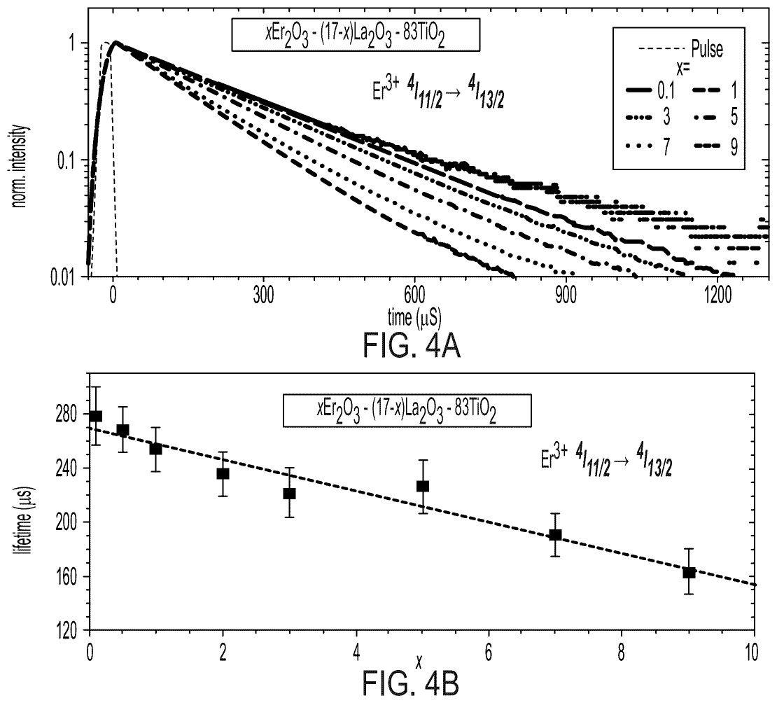

FIG. 4A plots the Er³⁺⁴I_{11/2}→⁴I_{13/2} an fluorescence decay curves measured using mechanically chopped 975 nm pump light (dotted line). The decays are non-monoexponential and were calculated using the mean lifetime method above (FIG. 4B). The lifetime of the ⁴I_{11/2}→⁴I_{13/2} decay of 0.1ErLT was measured to be 279±22 μs. This is in excellent agreement with what is reported in an Er³⁺ doped lead lanthanum zirconate titanate (PLZT) transparent ceramic by de Camargo et al., who measured τ≈280 μs for the 2.7 μm emission decay. In the classical laser crystal Er:YAG, this transition has a lifetime of about 120 μs. The lifetime steadily decreases as x increases from 0.1 to 9. At 9% Er₂O₃, the lifetime of the ⁴I_{11/2} level is 163 μs. Overall, the lifetime of ⁴I_{13/2} decreases at a faster rate than that of ⁴I_{11/2}, which is viewed as beneficial to laser operation of Er³⁺ at ≈2.8 μm.

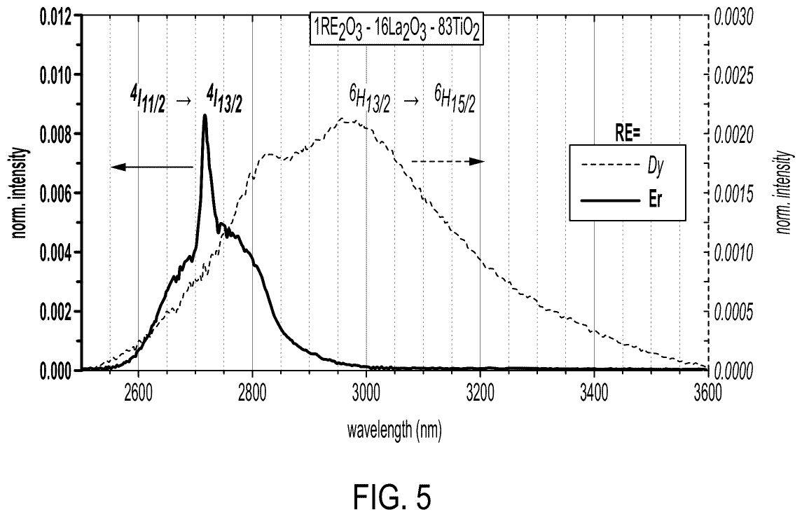

FIG. 5 shows a plot of area normalized mid-infrared fluorescence of 1RE₂O₃-16La₂O₃-83TiO₂ with RE=Dy in ligher dashed line and RE=Er in dak solid line. The mid-infrared fluorescence lineshapes of 1ErLT and 1DyLT are shown in FIG. 5. Spectra were acquired using the free space input port of a ThorLabs Redstone OSA305 scanning Michelson interferometer purged with flowing N₂. The spectrum for ⁴I^{11/2}→⁴I_{13/2} in 1ErLT was measured under 975 nm excitation (⁴I_{15/2}→⁴I_{11/2}) and required no correction. The lineshape is characterized by a peak wavelength at 2716 nm, a mean wavelength of 2746 nm and an effective linewidth of 125 nm. The corrected lineshape of the 1DyLT sample is characterized by a peak wavelength at 2957 nm, a mean wavelength of 2990 nm and an effective linewidth of 474 nm—although there is moderate uncertainty in these values given the necessity of the background correction. Overall though, the lineshape is very similar to that measured for sodium zinc tellurite (NZT) glass as well as for yttrium aluminum perovskite (YAP).

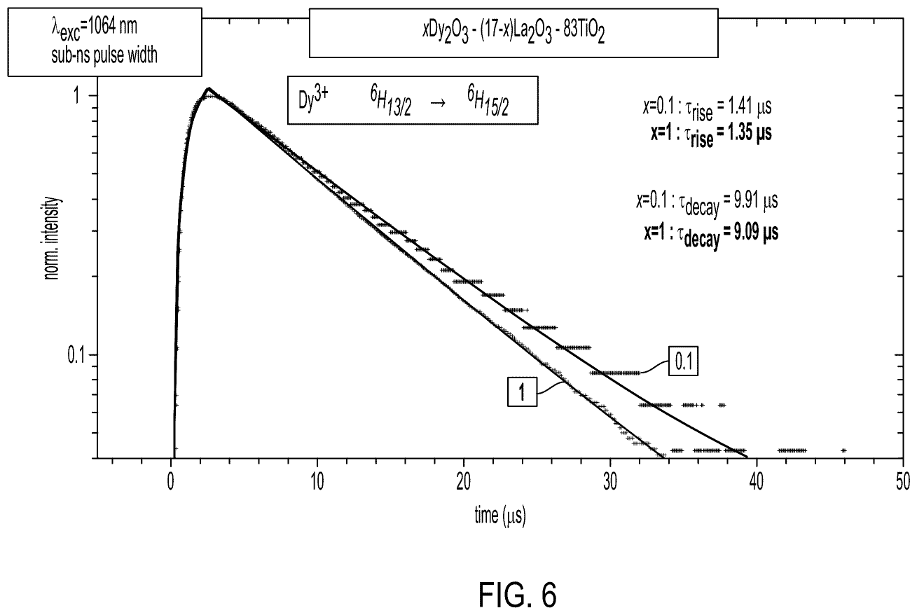

FIG. 6 shows a plot of normalized intensity versus time for Dy³⁺ ⁶H_{13/2}→⁶H_{15/2} fluorescence decays following 1064 nm pumping recorded with HgCdTe photodetector and 2950 nm bandpass filter. Discrete data points are experimentally measured and solid lines are bi-exponential fits. To measure the lifetime of the ⁶H_{13/2}M→⁶H_{15/2} in dysprosium doped lanthanum titanate glasses, a Q-switched Nd:YAG laser at 1064 nm was used to excite ⁶H_{15/2}→⁶H_{7/2}, ⁶F_{9/2} (see FIG. 2). The measured curves (FIG. 6) are described well by a bi-exponential to capture the filling of the ⁶H_{13/2} level and the subsequent decay to ⁶H_{15/2}. The fitted rise times are 1.41 and 1.35 μs for 0.1DyLT and 1DyLT, respectively, indicating the lifetimes of ⁶H_{7/2}, ⁶F_{9/2}, ⁶H_{9/2}, ⁶F_{11/2} and ⁶H_{11/2} levels are sufficiently short. The corresponding fitted decay times are 9.91 and 9.09 μs. It is worth mentioning here that Gomes et al. pumped an NZT glass with 3 wt % Dy³⁺ at 805 nm and measured τᵣᵢₛₑ=1.25 μs and τ_{decay}=9.7 μs.

Tellurites have received attention for over two decades as a material family for MIR applications due to the promise of good optical performance coupled with superior physical properties relative to fluorides and chalcogenides (sulphides, selenides, tellurides). It has been shown here through the time-dependent fluorescence measurements that mixed rare-earth titanate glasses have nearly identical near- and mid-infrared behavior to that reported for tellurites, with much higher intrinsic thermal stability. The ‘soft’ glass-like photonic properties of these glasses is likely rooted in their unique structural arrangements. Most glass-forming oxides produce three-dimensional networks of corner-sharing polyhedra where the average coordination number of the primary cation is 3 or 4. In contrast to this, rare-earth titanate glasses form an octahedral network with a significant fraction (≈20-30%) of edge-sharing polyhedra—strongly violating Zachariasen's rules. The phonon energy of corner and edge-sharing titanate polyhedra is approximately 740 and 630 cm⁻¹, respectively. The latter of these is close to the 600 cm⁻¹ stretching frequency of corner-sharing AlF₆ octahedra in fluoroaluminate glasses. These considerations suggest that the fairly low phonon energy sites (for a durable oxide glass) made possible by the unique rare-earth titanate glass network promote the desirable performance of active rare-earth ions.

Noting how Weber and co-workers pulled fibers from levitated rare-earth aluminate melts, it seems necessary to explore the possibility of drawing titanate fibers. Given the sensitivity of this process to melt viscosity, additional components may be necessary, though they should be chosen as to not increase the phonon energy of the system. Their high glass transition temperature implies that fibers based on mixed rare-earth titanate glasses may be viable materials for high power, high energy, and/or high intensity applications in the mid-infrared—assuming background losses are not prohibitively high. For example (assuming a step-index architecture could be achieved by means of a pseudo-double crucible procedure or a post-processing method) Raman fiber lasers with high gain bandwidths look very promising. In terms of active discs or fiber, co-doping schemes may reasonably be expected to increase the efficiency, such as Er/Pr, Er/Nd, or Dy/Tm.

Of course, while the current synthesis route of levitation melting allows up to around ≈7 mm spheres to be produced (depending on the fabrication instrument and composition), this is nowhere near the scale of large billets and preforms that can be produced with current technology using tellurites, germanates, gallates, and heavy metal oxide glasses. Nevertheless, the similarity of the spectroscopic properties of titanate glasses to these more established candidate oxide systems as seen here motivates future study of optically active titanates simply for deeper insight into glassy state of matter. Moreover, the high doping concentrations allowed in the types of reluctant glass formers that can prepared by the levitation method allow short material lengths with high effective gain, or other strong optical effects, when in a fiber, disc, or sphere geometry. This allows, in addition to the prospect of short gain fiber, the fabrication of in-line fiber or on-chip devices.

Lanthanum titanate glasses doped with erbium and dysprosium were prepared and studied. Disc samples were transparent throughout the entire 3-5 μm atmospheric window and showed very low hydroxyl content. The diverse structural arrangement of the titanate polyhedra yields a broad Raman gain spectrum with a 315 cm⁻¹ 3 dB bandwidth. The near infrared fluorescence from erbium was similarly broad, comparable to mixed anion glasses, and displayed an intrinsic lifetime of about 3 ms. Mid-infrared fluorescence from Er³⁺ and Dy³⁺ were comparable to what is found in tellurites. Although the Dy³⁺ lifetime is likely too short to allow efficient lasing, the Er³⁺ MIR lifetime is very promising.

Glass is an enabling component for many optical products. The ability to make chemically homogeneous glass products from a wide range of compositions, to make glasses into useful shapes, and to polish and/or optically coat surfaces all provide unique qualities that cannot be obtained in other materials. According to examples of the present disclosure, glasses that contain optically active ions of rare earth elements are disclosed. The properties of both the optically active components and the host materials affect the fluorescence and optical behavior of the product. For example, the chemical composition, spatial distribution, and degree of ordering of an optical material can affect its phonon energy, optical energy transfer between ions, refractive index and density in ways that modify optical behavior. One or more of the materials disclosed herein provide capabilities to achieve optical excitation and emission at various wavelengths. The materials show a variety of optical properties that are potentially useful in laser, optical amplifier, lighting, quantum devices and other optical applications that require control and manipulation of electromagnetic radiation intensity, power, wavelength, frequency, pulse energy, coherence, modality, temporality, or spatiality.

The subject glasses are based on titanium oxide—rare earth metal oxide compositions. The rare earth oxides for purposes of this patent are defined as being oxides of the metals scandium, yttrium, lanthanum, cerium, praseodymium, neodymium, promethium, samarium, europium, gadolinium, terbium, dysprosium, holmium, erbium, thulium, ytterbium, and lutetium. For the purposes of this patent, titanium oxide is considered to be predominantly the compound with a stoichiometry of TiO₂. Titanium oxides are well known to exhibit a range of metal to oxygen stoichiometry due to the possible presence of both Ti⁴⁺ and Ti³⁺ oxidation states. It is expected that during the process of being incorporated into a glass some changes in the oxidation state of titanium may take place, in some cases. The oxidation state of the titanium can be influenced during synthesis to some extent by the atmospheric conditions.

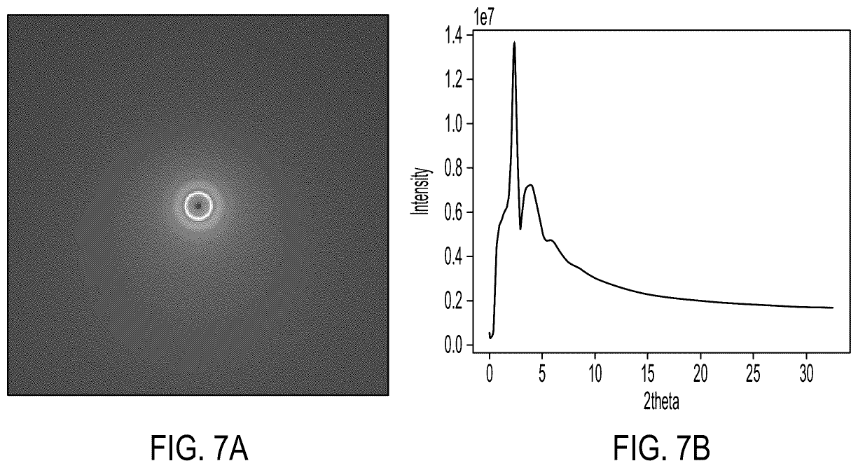

Very sensitive X-ray diffraction measurements using high energy synchrotron radiation confirm the absence of even traces of crystalline components in glass samples. FIG. 7A shows a high energy x-ray diffraction of a typical glass sample. The diffraction shows only diffuse scattering that occurs in samples without long range order—i.e. those that do not contain crystals. FIG. 7B shows a plot of intensity versus 2theta for the x-ray diffraction of FIG. 7A.

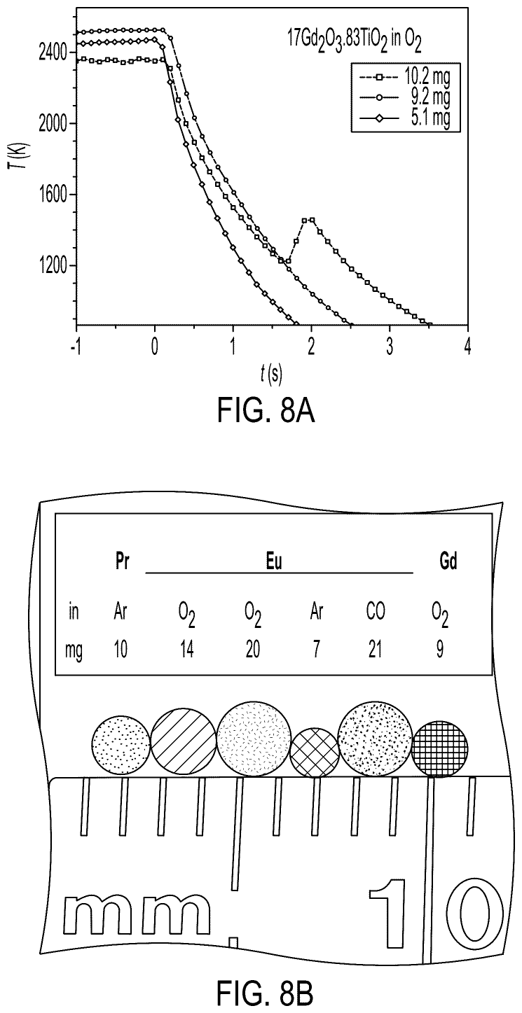

FIG. 8A shows a plot of examples of temperature-time data for processing a sample in a non-contact levitation instrument. The material is initially heated to a temperature of about 2300-2500° C. After holding for a short time sufficient to ensure complete melting of any solid materials present, the liquid drop is cooled. In cases where the cooling rate is adequate to avoid crystallization, the cooling occurs smoothly. In cases where crystals form, the heat of crystallization (latent heat of fusion) causes the material to heat up and causes a “spike” in the temperature-time data (at about 2 seconds for the 10.2 mg sample).

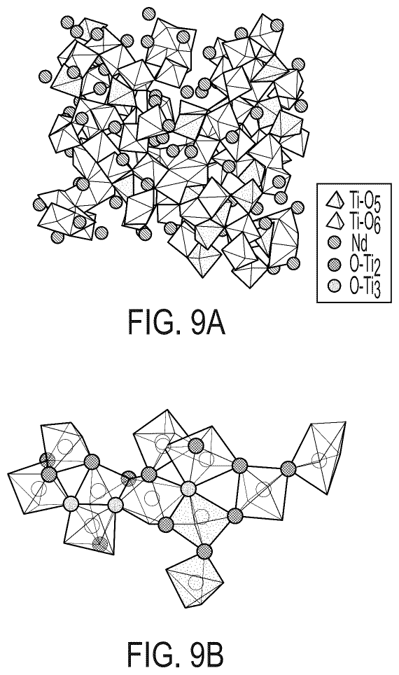

FIG. 8A shows a plot of examples of temperature-time data for processing samples in a non-contact levitation instrument. FIG. 8B shows various glass compositions prepared by melting crystalline materials and cooling them to avoid formation of crystals. From L. Gomes, J. Lousteau, D. Milanese, E. Mura, and S. D. Jackson, “Spectroscopy of mid-infrared (2.9 μm) fluorescence and energy transfer in Dy³⁺-doped tellurite glasses,” J. Opt. Soc. Am. B 31(3), 429-435 (2014). Recent work by the inventors has shown that the atomic structure in rare earth titanate glasses comprise an octahedrally coordinated titanate species that forms the glass network. A visualization of the atomic structure of the glasses is shown in FIG. 9A and FIG. 9B. The rare earth metal ions are dispersed in the network to achieve a homogeneous and optically isotropic product. Prior work has demonstrated formation of several rare earth titanate compositions made by using a non-contact levitation melting method.

Some example compositions of the subject materials are given in Table I A and Table I B. Many other compositions could be envisioned that would meet the requirements for glass formation that have been established; for example, different ratios of rare earth metal oxides to titanium oxide. Also, as is well known in the art, the addition of other components such as silicon, calcium and aluminum oxides, for example, that improve glass forming ability and glass working behavior are anticipated.

TABLE I
A. Example compositions containing only titanium,
lanthanum and erbium oxides. Oxides are listed
as nominal oxidation state in all cases.

| Molar % | Molar % | Molar % | Average RE ionic | |
|---|---|---|---|---|
| TiO2 | La2O3 | Er2O3 | radius (Å) | Product |
| 83.0 | 16.9 | 0.1 | 1.032 | Glass |
| 83.0 | 16.5 | 0.5 | 1.031 | Glass |
| 83.0 | 16.0 | 1.0 | 1.028 | Glass |
| 83.0 | 15.0 | 2.0 | 1.024 | Glass |
| 83.0 | 14.0 | 3.0 | 1.015 | Glass |
| 83.0 | 13.0 | 4.0 | 1.007 | Glass |
| 83.0 | 12.0 | 5.0 | 0.999 | Glass |
| 83.0 | 10.0 | 7.0 | 0.990 | Glass |
| 83.0 | 8.0 | 9.0 | 0.974 | Glass |
| 83.0 | 6.0 | 11.0 | 0.957 | Crystals |

TABLE I
B. Example compositions containing other rare earth oxides. Oxides
are listed as nominal oxidation state in all cases. Many other
compositions with similar stoichiometry and various combinations
of rare earth elements could easily be envisioned.

| Molar % | Molar % | Molar % | Molar % | Average RE ionic | |
|---|---|---|---|---|---|
| TiO₂ | RE₂O₃ | RE₂O₃ | RE₂O₃ | radius (Å) | Product |
| 83.0 | 16.9 (La₂O₃) | 0.1 (Dy₂O₃) | -0- | 1.06 | Glass |
| 83.0 | 16.0 (La₂O₃) | 1.0 (Dy₂O₃) | -0- | 1.06 | Glass |
| 83.0 | 15.9 (La₂O₃) | 1.0 (Yb₂O₃) | 0.1 (Er₂O₃) | 1.05 | Glass |
| 83.0 | 17.0 (Pr₂O₃) | -0- | -0- | 1.01 | Glass |
| 83.0 | 17.0 (Gd₂O₃) | -0- | -0- | 0.94 | Glass |
| 83.0 | 17.0 (Eu₂O₃) | -0- | -0- | 0.95 | Glass |
| 83.0 | 17.0 (Sc₂O₃) | -0- | -0- | 0.73 | Crystal |

The shows that glass formation occurs most readily in cases where the ionic radius of the rare earth ions exceeds a value of ca. 0.95 Å (9.5×10⁻¹⁰ in). Furthermore, high quality glasses can be formed when the average rare earth ionic radius is ca. 0.95 Å or larger, even when larger and smaller rare earth ions are mixed together to achieve a sufficient average rare earth ion radius. In addition, the ability to mix larger and smaller rare earth ions provides a means to optimize compositions to achieve useful optical and possibly other properties. In general, it was shown that the larger the average rare earth ionic radius, the easier it was to make glass products. Examples of rare earth metal ionic radii are given in Table II.

TABLE II
Ionic radius of rare earth elements in 3+ oxidation
state and in sixfold (octahedral) coordination.

| Rare earth element (3+ oxidation) | Ionic radius (6-fold), (Å)# |
|---|---|
| Scandium | 0.73 |
| Yttrium | 0.89 |
| Lanthanum | 1.06 |
| Cerium | 1.03 |
| Praseodymium | 1.01 |
| Neodymium | 1.00 |
| Promethium | 0.98 |
| Samarium | 0.96 |
| Europium | 0.95 |
| Gadolinium | 0.94 |
| Terbium | 0.92 |
| Dysprosium | 0.91 |
| Holmium | 0.89 |
| Erbium | 0.88 |
| Thulium | 0.87 |
| Ytterbium | 0.86 |
| Lutetium | 0.85 |

#Data from D. J. Coleman, S. D. Jackson, P. Golding, and T. A. King, “Measurements of the spectroscopic and energy transfer parameters for Er³⁺-doped and Er³⁺, Pr³⁺-codoped PbO—Bi₂O₃—Ga₂O₃ glasses,” J. Opt. Soc. Am. B 19(12), 2927-2937 (2002).

The presence of trivalent erbium ions enables fluorescence in the visible, near infrared, and mid-infrared wavelength ranges. Addition of trivalent ytterbium ions can enable strong absorption of wavelengths of around 980 nm that can also be used to optically excite erbium ions. Energy transfer between ytterbium and other ions, such as erbium, can potentially be used to achieve enhanced utilization of optical power to improve the efficiency and output of a device.

In one non-limiting example of the present disclosure, glass disks can be formed by forming spheres of glass from levitated drops of liquid. The process uses aerodynamic forces to suspend material that is heated using a carbon dioxide laser beam.

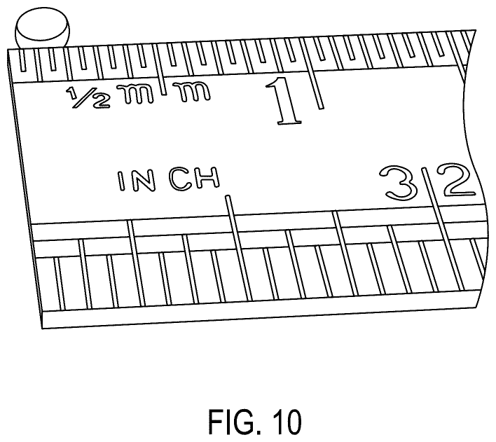

FIG. 10 shows an example of a disc fabricated from a sphere similar to those presented FIG. 8B. Another example of the present disclosure involves creating a thin disk of material that is polished on two flat and approximately parallel surfaces (FIG. 10). The described glass disk is optically excited by application of light at specific wavelengths and intensities. Due to the isotropic nature of the amorphous state, the geometry of the optical excitation is not restricted by any directionality nor any orientation.

All compositions stated would contain small traces of impurities. These may include almost any element that is either present in the material from its original source or becomes incorporated due to contamination. Trace impurities are not required to meet the purposes of this patent. In some cases, impurities may cause unwanted effects. In these cases, the purity of the starting materials would be specified, for example “99.999% metallic purity” or sufficient to avoid unwanted effects due to the presence of specific impurities. Intentional co-doping, in any amount greater than or equal to parts per billion, does not constitute an impurity. Impurities are restricted to elements that are unknowingly included.

The following figures represent optical properties characteristic of the erbium lanthanum titanate glasses. FIG. 1A shows plots of infrared transmission spectrum. Infrared transmission measurements were taken on a Shimadzu IRSpirit Fourier Transform Infrared Spectrophotometer over the range 1000-7900 cm⁻¹. The horizontal axis is frequency in wavenumbers with units of inverse centimeters. The vertical axis is in transmittance with units of percent. The materials show good transparency out to 5 microns and quickly become opaque beyond 6 microns in the thicknesses that were measured. The low hydroxyl species content of the glasses is evidenced by the undisrupted transmission between 3000-3500 cm⁻¹ where OH— ions absorb strongly.

Absorbance measurements were made in transmission mode using an Agilent Cary 7000 UV-Vis-NIR Spectrophotometer over the range 350-2000 nm. The resolution in the range 350-800 nm was 1 nm and the resolution for measurements in the 800-2000 nm range was 2.2 nm. FIG. 2 shows a plot of absorbance measurements of 1RE₂O₃-16La₂O₃-83TiO₂ glasses for RE=Er, Dy. The horizontal axis is frequency in wavelength units. The vertical axis is the absorbance measured by a commercial spectrometer The absorption measurements in FIG. 2 were made on the glass disc with approximately plane parallel geometry and thicknesses given in Table III.

FIG. 3A shows a plot of emission lineshape corresponding to ⁴I_{13/2}-⁴I_{15/2} transition in 0.1Er₂O₃-16.9La₂O₃-83TiO₂ glass. Optical measurements were made by exciting the sample at approximately a 45-degree incidence angle and monitoring the sample perpendicular to the incident radiation. Near infrared emission from 1400-1700 nm was collected with a silicate lens array coupled to a multimode fiber and recorded on a Yokogawa AQ6319 Optical Spectrum Analyzer with a 1 nm resolution. A 980 nm notch filter reduced stray scattered light from the pump source. As shown in FIG. 3A, the normalized fluorescence intensity of the ⁴I_{13/2}-⁴I_{15/2} electronic transition is shown where the horizontal axis is wavelength in units of nanometers and the vertical axis is the normalized intensity in arbitrary units. The emission band peaks at 1532 nm and is characterized by a mean wavelength of 1542 nm. The lack of variance in the absorption lineshape with increasing erbium concentration indicates that the intrinsic fluorescence lineshape should remain similarly independent of erbium concentration. FIG. 3B shows the fluorescence decay of the ⁴I_{13/2}-⁴I_{15/2} transition in the time-domain. FIG. 3C shows the measured fluorescence lifetime of the ⁴I_{13/2}-⁴I_{15/2} transition as a function of Er₂O₃ content. The initial increase is likely due to self-absorption effects followed by a decrease due to quenching effects.

FIG. 4A shows a plot of some mid-infrared fluorescence decay curves for erbium lanthanum titanate glasses at the ⁴I_{11/2}-⁴I_{13/2} transition. FIG. 4B shows measured lifetimes of the ⁴I_{11/2}-⁴I_{13/2} as a function of Er₂O₃ content.

FIG. 5 shows mid-infrared fluorescence lineshapes for the Er^{3+ 4}I_{11/2}→⁴I_{13/2} and Dy³⁺ ⁶H_{13/2}→⁶H_{15/2} transitions.

FIG. 6 shows mid-infrared fluorescence decay in the time-domain for the Dy³⁺ ⁶H_{13/2}→⁶H_{15/2} transition.

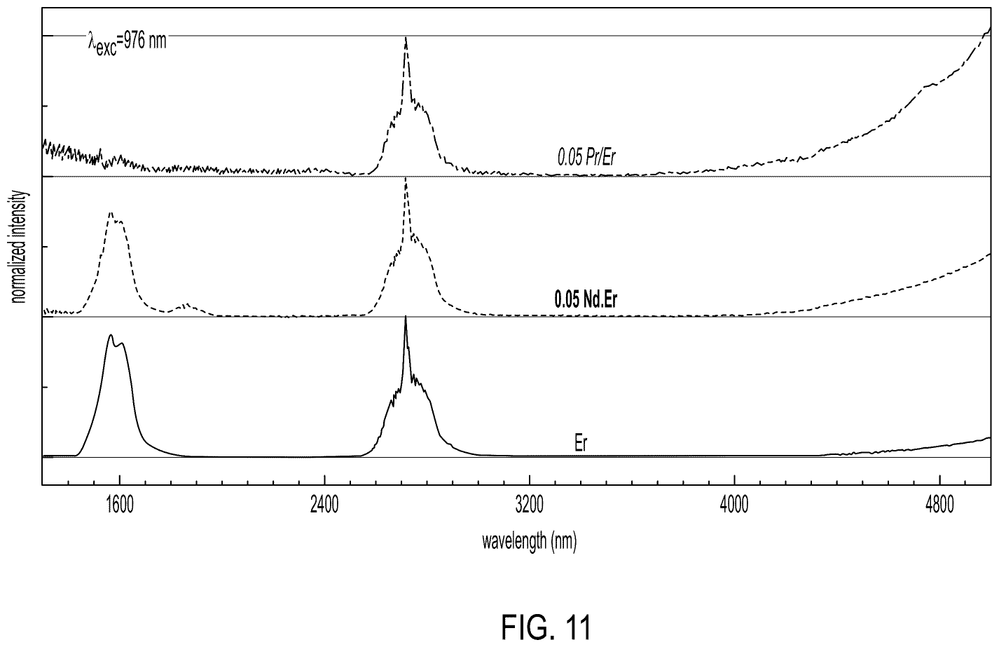

FIG. 11 shows the near and mid-infrared fluorescence spectra of 5Er₂O₃-12La₂O₃-83TiO₂ (bottom line), 0.05Nd₂O₃-5Er₂O₃-11.95La₂O₃-83TiO₂ (middle line), and 0.05Pr₂O₃-5Er₂O₃-11.95La₂O₃-83TiO₂ (top line) measured under 976 nm excitation.

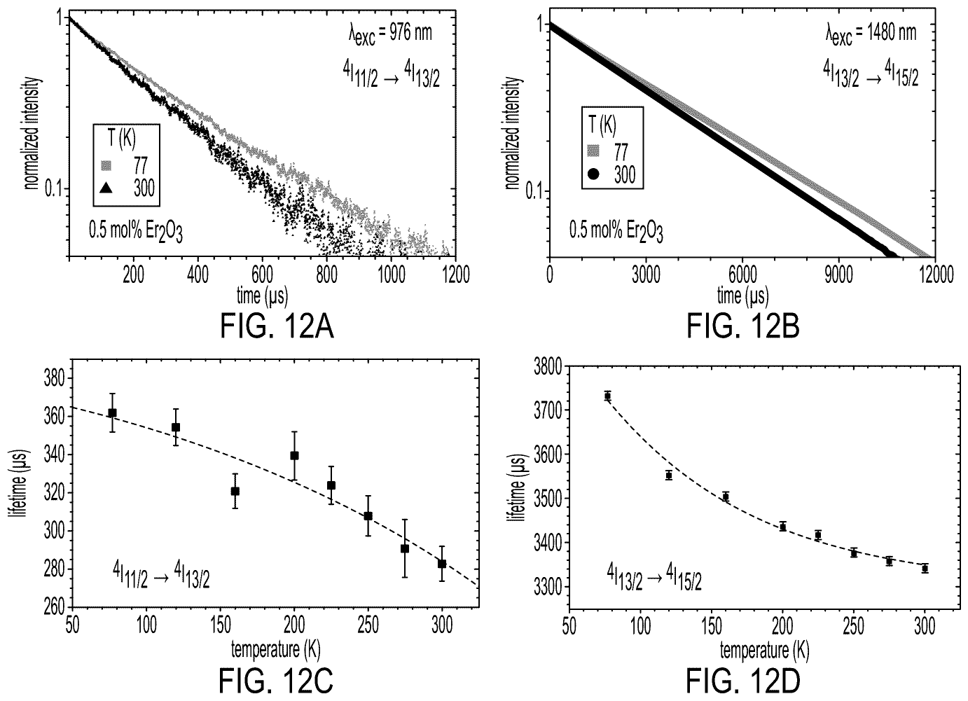

FIG. 12A, FIG. 12B, FIG. 12C, and FIG. 12D show in (FIG. 12A, FIG. 12B) the fluorescence decay curves at 77 K (top line) and 300 K (bottom line) for ⁴I_{11/2} (FIG. 12A) and ⁴I_{13/2} (FIG. 12B) and in (FIG. 12C, FIG. 12D) the lifetime versus temperature for ⁴I_{11/2} (FIG. 12C) and ⁴I_{13/2} (FIG. 12D). The broken lines are drawn to guide the eyes.

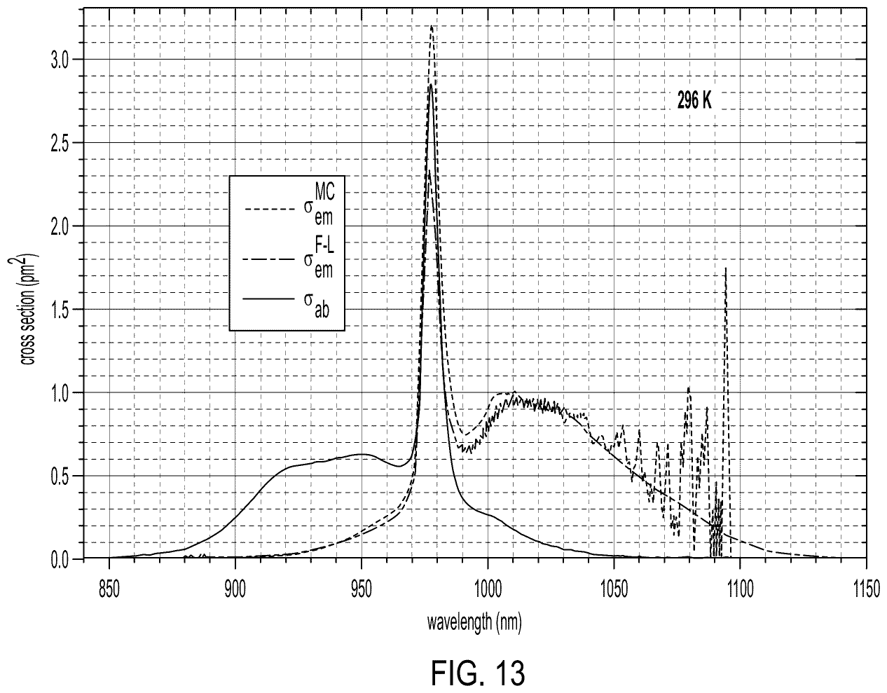

FIG. 13 shows the calculated room temperature cross-sections of Yb³⁺ in lanthanum titanate glass, where the absorption cross-section, the emission cross-section determined by McCumber theory, the emission cross-section calculated using the fluorescence spectrum acquired under 900 nm excitation at room temperature and the F'uchtbauerLadenburg equation are shown as indicated in the legend.

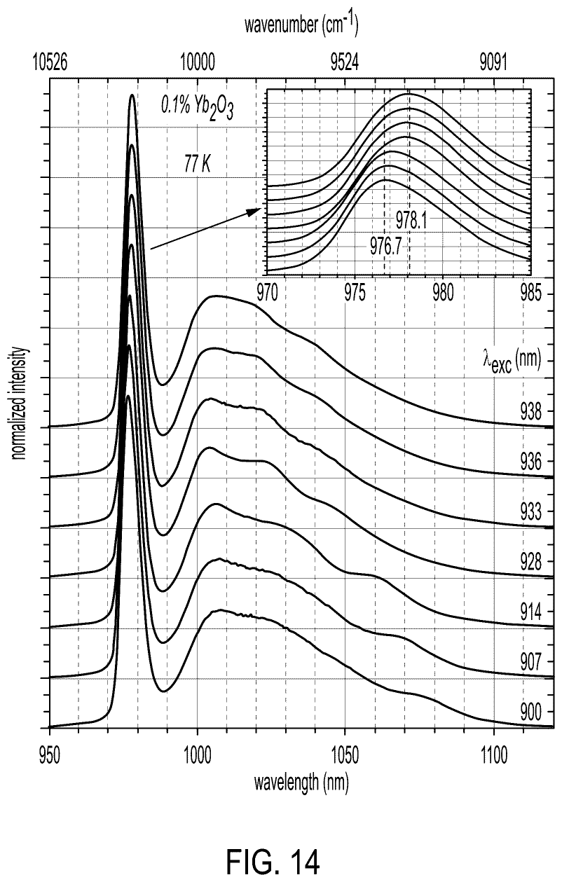

FIG. 14 shows site-selective emission measurements of Yb³⁺ in lanthanum titanate glass host at 77 K.

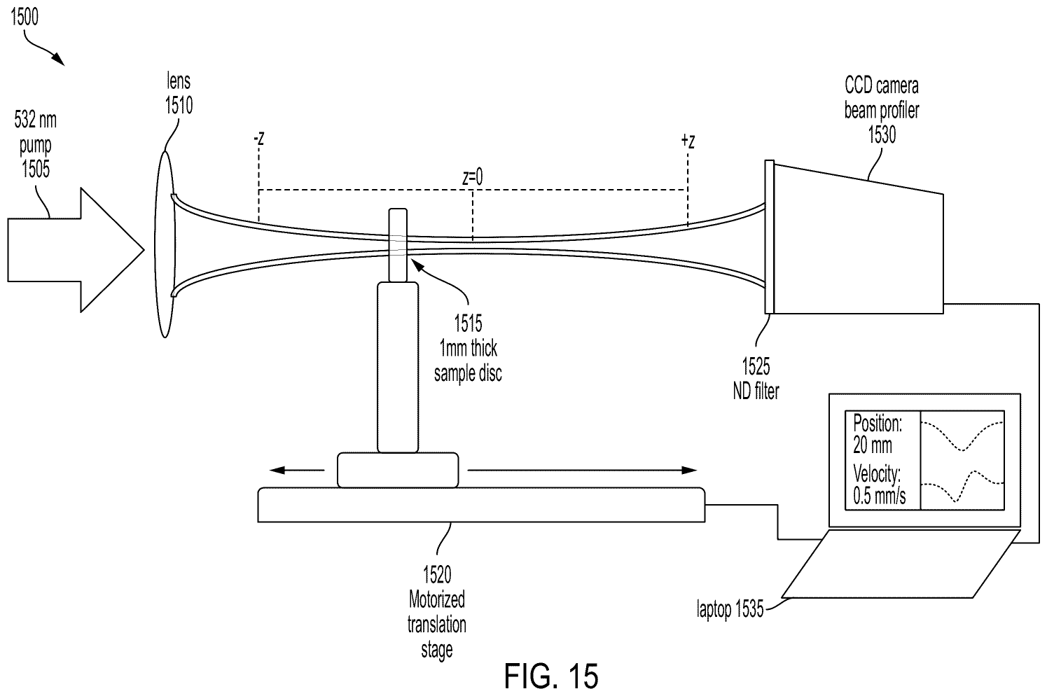

FIG. 15 shows the configuration 1500 used to measured optical nonlinearities with a Z scan. The configuration 1500 shows a pump laser beam 1505, such as a 532 nm laser beam, that is focused by lens 1510 onto a sample 1515, such as a 1 mm thick sample disc. The sample 1515 is mounted on a support that is actuated using a motorized translation stage 1520. The laser beam that is transmitted through the sample 1515 is incident onto a neutral density (ND) filter 1525, which is arranged on a detecting surface of a CCD camera and beam profiler 1530. A computer 1535, such as a laptop, is coupled with the motorized translation stage 1520 to control actuation and the CCD camera and beam profile 1530 to analyze the results.

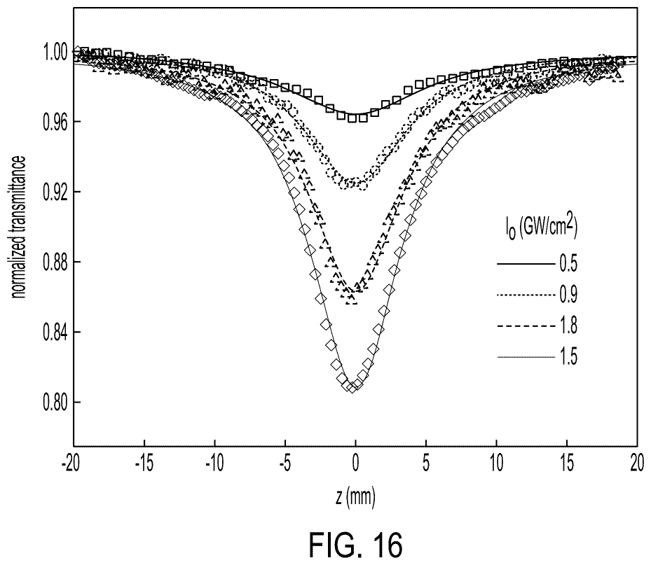

FIG. 16 shows normalized transmittance as a function of z for different incident intensities of 550 μs 532 nm light using for 17La₂O₃-83TiO₂.

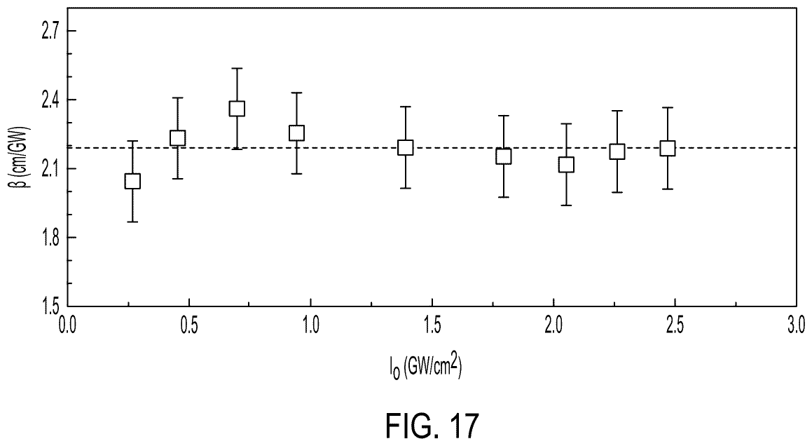

FIG. 17 shows nonlinear absorption coefficient, β, as a function of incident intensity for 17La₂O₃-83TiO₂. As shown in FIG. 17, the two-photon absorption coefficient β measured for different peak intensities inside the sample is shown. The dashed line is the mean value of all measurements. Error bars represent two standard deviations of the measured values.

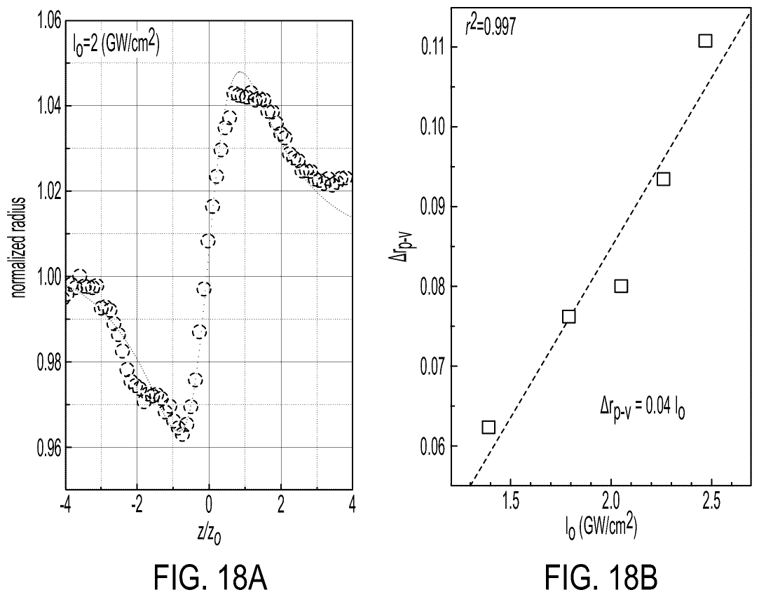

FIG. 18A and FIG. 18B show the experimental change in beam radius with z for trial with I₀=2 GW/cm² in FIG. 18A and the peak-valley distances of radius measurements for different intensities (symbols) plotted with linear fit intercepting 0 (dashed line) in FIG. 18B. As shown in FIG. 18A, the change in normalized radius of a beam after passing through lanthanum titanate glass as a function of z for 532 nm light at 550 ps pulses with a peak intensity of 2 GW/cm² (left) is shown and FIG. 18B shows the distance between the peak and valley of the radius as a function of peak incident intensity.

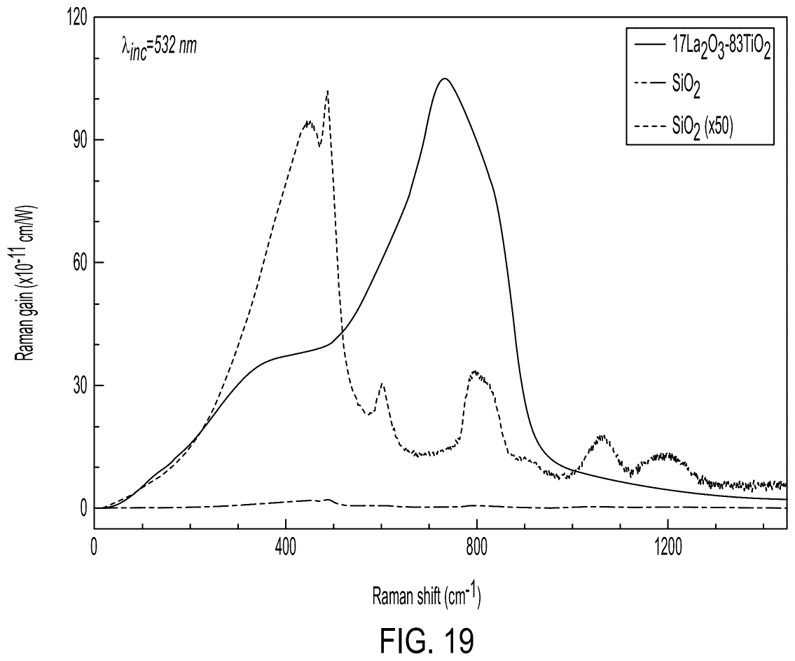

FIG. 19 shows the Raman gain coefficient spectra of 17La₂O₃-83TiO₂ glass (solid line) and SiO₂ (dotted line). Normalization was done by setting the Raman gain coefficient at 440 cm⁻¹ in silica to 1.86×10⁻¹¹ cm/W. For visual aide, the spectrum of SiO₂ has been multiplied by 50 (dotted dashed line).

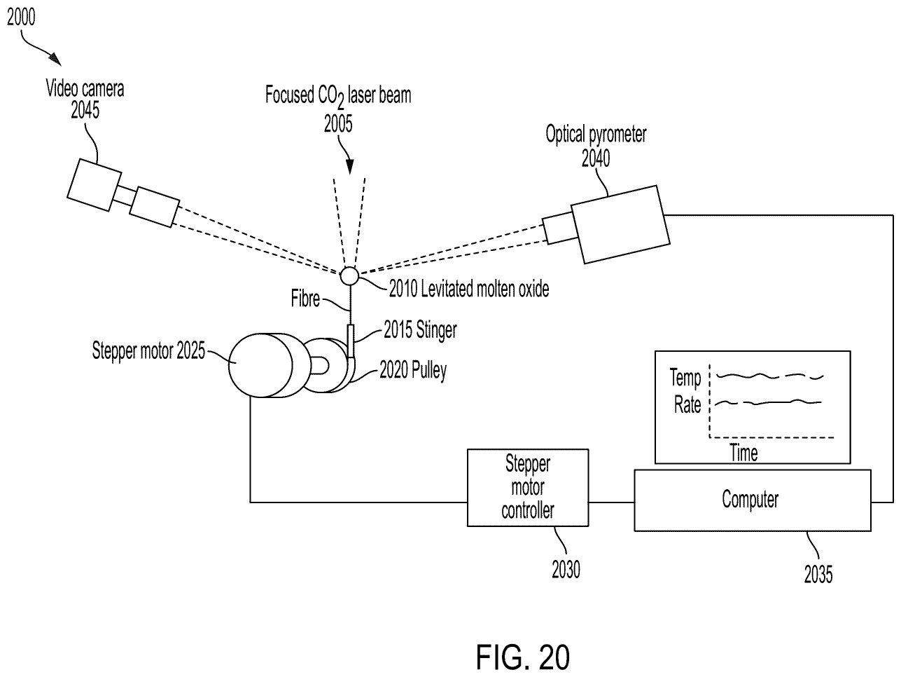

FIG. 20 shows a schematic diagram 2000 of the processing setup used to draw test fibers from selected compositions. The schematic diagram 2000 shows a focused CO₂ laser beam 2005 directed to a metal oxide to melt the metal oxide that results in a levitated molten oxide 2010. The levitated molten oxide 2010 is elongated using a stringer 2015 using a pully 2020 that is actuated by a stepper motor 2025 that is controlled by a stepper motor controller 2030. A computer 2035 is used to monitor and control various conditions of the stepper motor controller 2030 and an optical pyrometer 2040 during the manufacturing process. The optical pyrometer 2040 detects infrared radiation emitted during the manufacturing processes of the levitated molten oxide 2010 and provides a signal to the computer 2035 to provide control to the stepper motor controller 2030.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A glass product with a composition comprising at least 50 molar percent titanium dioxide and at least 0.1 molar percent rare earth metal oxide wherein the rare earth is at least one of the following elements: scandium, yttrium, lanthanum, cerium, praseodymium, neodymium, promethium, samarium, europium, gadolinium, terbium, dysprosium, holmium, erbium, thulium, ytterbium, lutetium.

2. The glass of claim 1 further comprising at least 0.1 molar percent of at least one oxide of the following metals: aluminum, barium, calcium, magnesium, hafnium, niobium, silicon, strontium, tantalum, zirconium.

3. The glass of claim 1 further comprising at least 75 molar percent titanium dioxide.

4. The glass of claim 1 further comprising at least 1 molar percent rare earth oxide.

5. The glass of claim 1 further comprising at least 0.01 molar percent erbium oxide.

6. The glass of claim 1 further comprising at least 0.01 molar percent ytterbium oxide.

7. The glass of claim 1 further comprising at least 0.01 molar percent each of both erbium oxide and ytterbium oxide.

8. The glass of claim 2 further comprising at least 75 molar percent titanium dioxide.

9. The glass of claim 2 further comprising at least 1 molar percent rare earth oxide.

10. The glass of claim 2 further comprising at least 0.01 molar percent erbium oxide.

11. The glass of claim 2 further comprising at least 0.01 molar percent ytterbium oxide.

12. The glass of claim 2 further comprising at least 0.01 molar percent each of erbium oxide and ytterbium oxide.

13. An optical system comprising:
a glass product with a composition comprising at least 50 molar percent titanium dioxide and at least 0.1 molar percent rare earth metal oxide wherein the rare earth is at least one of the following elements: scandium, yttrium, lanthanum, cerium, praseodymium, neodymium, promethium, samarium, europium, gadolinium, terbium, dysprosium, holmium, erbium, thulium, ytterbium, lutetium, wherein the glass product has a glass transition temperature of at least 650° C. and that is substantially free of hydroxyl ions and that can transmit light within the 6 dB bandwidth to a wavelength of approximately 6 μm through a thicknesses of at least 1 mm.

14. The optical system of claim 13, wherein the glass product has a Raman gain bandwidth of at least 275 cm⁻¹.

15. The optical system of claim 13, wherein the glass product exhibits a nonlinear refractive index of at least 125*10⁻⁶ cm²/W when measured at a wavelength of 532 nm, a nonlinear absorption coefficient of at least 2 cm/GW when measured at a wavelength of 532 nm, and a Raman gain of coefficient of at least 100*10⁻¹¹ cm/W when measured at a wavelength of 532 nm.

16. The optical system of claim 13, wherein the glass product is shaped as a sphere, a disc, or a clad or unclad fiber or waveguide.
